(19) United States
(12) Patent Application Publication
(10) Pub. No.: US 2017/0369318 A1
(43) Pub. Date: Dec. 28, 2017

(54) CNT FOREST, METHOD FOR PRODUCING CNT FOREST, SPINNING SOURCE MEMBER, STRUCTURE, AND METHOD FOR PRODUCING STRUCTURE

(71) Applicants: NATIONAL UNIVERSITY CORPORATION SHIZUOKA UNIVERSITY, Shizuoka (JP); JNC CORPORATION, Tokyo (JP)

(72) Inventors: Yoku INOUE, Hamamatsu Shizuoka (JP); Takayuki NAKANO, Hamamatsu Shizuoka (JP); Tauto NAKANISHI, Ichihara-shi, Chiba (JP)

(21) Appl. No.: 15/543,833

(22) PCT Filed: Oct. 26, 2015
(86) PCT No.: PCT/JP2015/080101

§ 371 Date: Jul. 14, 2017

(30) Foreign Application Priority Data
Jan. 23, 2015 (JP) 2015-011349

(51) Int. Cl. C01B 32/16; D01H 7/00; D07B 1/00

(52) U.S. Cl. CPC C01B 32/16; D07B 1/005; D01H 7/00; D07B 2205/3007

(57) ABSTRACT

Provided are a CNT forest having favorable spinning properties, and as a method for producing such a CNT forest, a production method in which CNT forest 45 is formed by applying, as deposition base surface 44, a surface including at least one part of inner surface 43 in opening substrate 40 having interior space 42 communicating with an outside through open portion 41, and CNT forest 45 has spinnable portion 47 at end 46 on a side of open portion 41.

### TECHNICAL FIELD

The invention relates to a CNT forest, a method for producing the CNT forest, a spinning source member, a structure and a method for producing the structure.

“CNT forest” herein means one kind of composite structure (hereinafter, each shape of CNT giving such composite structure is referred to as “primary structure,” and the composite structure described above is also referred to as “secondary structure”) of a plurality of carbon nanotubes (also referred to as “CNT” herein), and an aggregate of CNT as formed by deposition of the plurality of CNT so as to align in a predetermined direction (specific one example includes a direction substantially in parallel to one normal line on a plane of a substrate) with regard to at least one part in a major axis direction. In addition, a length (height) of the CNT forest deposited from a deposition base surface in the direction in parallel to the normal line of the deposition base surface in a state in which the CNT forest is attached on the deposition base surface is referred to as “deposition height.” With regard to the secondary structure of the CNT forest, when the CNT forest is formed on a substrate consisting essentially of one plane, the plurality of CNT are aligned substantially in parallel for at least one part of the long axis direction. In contrast, when the CNT forest is formed on a substrate having a plurality of planes or curved surfaces, the plurality of CNT are aligned in non-parallel in such a manner that straight lines formed by being extended in the major axis of CNT are intersected to each other.

Moreover, a structure having a configuration in which the plurality of CNT are entangled to each other herein is referred to as “CNT entangled body,” in which the structure is formed by continuously drawing the plurality of CNT from the CNT forest by pulling one part of CNT of the CNT forest so as to be separated from the CNT forest (work therefor herein is also referred to as “spinning” after work for producing threads from fibers as related to a conventional technology). “Spinnable” herein means that a spinning length (length in a spinning direction) can be increased to 1 centimeter or more.

### BACKGROUND ART

CNT has a specific configuration of having an outside surface formed of graphene, and therefore an application in various fields is expected as a functional material and also as a structural material. Specifically, the CNT has excellent characteristics such as high mechanical strength, light weight, favorable electrical conduction characteristics, favorable heat characteristics such as heat resistance and heat conductivity, high resistance to chemical corrosion and favorable field electron emission characteristics. Accordingly, a use of the CNT is considered to be a lightweight and high strength wire, a probe of a scanning probe microscope (SPM), a cold cathode of a field emission display (FED), an electrically conductive resin, a high strength resin, a corrosion-resistant resin, a wear-resistant resin, a highly lubricating resin, an electrode of a secondary battery or a fuel cell, an interlayer wiring material for LSI, a biosensor or the like.

As one of methods for producing the CNT, Patent literature No. 1 discloses a method for preforming a solid-phase metal catalyst layer on a surface of a substrate by vapor-depositing a thin film of a metallic material by a means such as sputtering, arranging the substrate having the solid-phase metal catalyst layer in a reactor, forming catalyst particles serving as a deposition nucleus on the substrate from the metal catalyst layer, and supplying a hydrocarbon gas to the reactor to form a CNT forest on the substrate. Hereinafter, the method for producing the CNT forest by forming the solid-phase catalyst particles serving as the deposition nucleus on the substrate and supplying a hydrocarbon-based material to the reactor in which the substrate having the solid-phase catalyst particles is provided, as described above, is referred to as a solid-phase catalyst process.

As a method for producing a CNT forest with high efficiency by a solid-phase catalyst process, Patent literature No. 2 discloses a method for supplying a raw material gas containing carbon and no oxygen, a catalyst activator containing oxygen and an atmospheric gas, while predetermined conditions are met, and being brought into contact with a solid-phase catalyst layer.

A method for producing a CNT forest by a method different from the method described above is also disclosed. More specifically, Patent literature No. 3 discloses a method for sublimating iron chloride, and forming a catalyst serving as a deposition nucleus on a substrate by applying the sublimated substance as a precursor to form the CNT forest by using the catalyst. The method is substantially different from the technologies disclosed in Patent literature No. 1 or 2 in applying, as a catalyst precursor, a substance that contains halogen and is in a gas-phase state to form the catalyst by using the substance. The method for producing the CNT forest as disclosed in Patent literature No. 3 is also referred to as a gas-phase catalyst process herein.

### CITATION LIST

### Patent Literature

Patent literature No. 1: JP 2004-107196 A.

Patent literature No. 2: JP 4803687 B.

Patent literature No. 3: JP 2009-196873 A.

### SUMMARY OF INVENTION

### Technical Problem

In both a solid-phase catalyst process and a gas-phase catalyst process, CNT entangled bodies having various shapes are produced by spinning a spinning source member including a CNT forest obtained. Ease of production of the CNT entangled body, namely, improvement in spinning properties is desired. However, the CNT forest is a relatively new material, shapes that can be taken by a CNT entangled are various, or the like. Thus, what kind of CNT forest has excellent spinning properties has been not known yet.

An object of the invention is to provide a means for improving spinning properties of a CNT forest. Another object of the invention is to provide a method for producing such a CNT forest. A further object of the invention is to provide a spinning source member including the CNT forest and a structure spun from the spinning source member.

### Solution to Problem

The inventors have continued to conduct study in order to solve the problems described above. As a result, the present inventors have obtained new findings in which CNT can be drawn so as to form a spindle shape and spinning properties of a CNT forest are possibly improved by forming a construction of including a spinnable portion at an end on a side of an open portion, in an opening substrate, of a CNT forest formed by applying, as a deposition base surface, an inner surface of the opening substrate having an interior space.

The invention provided for solving the above problems is as described below.

Item 1. A CNT forest that is formed by applying, as a deposition base surface, at least one part of an inner surface in an opening substrate having an interior space communicating with an outside through an open portion, wherein the CNT forest has a spinnable portion at an end of the open portion.

Item 2. The CNT forest according to item 1, wherein the spinnable portion is formed wholly at the end of the open portion.

Item 3. The CNT forest according to item 1 or item 2, wherein the opening substrate has at least two of the open portions.

Item 4. The CNT forest according to item 3, wherein the opening substrate is tubular.

Item 5. The CNT forest according to item 4, wherein the opening substrate is a bilaterally opening substrate in which the open portions are formed on both ends of the opening substrate being tubular.

Item 6. The CNT forest according to item 5, wherein the opening substrate is cylindrical.

Item 7. A method for producing a CNT forest, including a deposition process of forming the CNT forest on the deposition base surface of the opening substrate according to any one of items 1 to 6.

Item 8. The method for producing the CNT forest according to item 7, wherein the deposition process includes a first step of allowing the opening substrate to exist in an atmosphere containing a gas-phase catalyst, and a second step of depositing a plurality of carbon nanotubes on a deposition base surface of the opening substrate by allowing a raw material gas and a gas-phase co-catalyst to exist in the atmosphere containing the gas-phase catalyst to obtain the CNT forest constituted of the plurality of carbon nanotubes on the deposition base surface.

Item 9. A spinning source member, including the CNT forest according to any one of items 1 to 6.

Item 10. A structure, spun from the spinning source member according to claim 9, and the structure, including a plurality of carbon nanotubes entangled to each other.

Item 11. The structure according to item 10, wherein a length of the structure in a spinning direction is 10 millimeters or more.

Item 12. The structure according to item 10 or 11, wherein the structure is a web-like structure.

Item 13. The structure according to item 12, wherein the web-like structure has an inside surface and an outside surface.

Item 14. The structure according to item 10 or 11, wherein the structure is a linear structure.

Item 15. The structure according to item 14, wherein the linear structure includes, in at least one part, a configuration in which the carbon nanotubes are bundled by twisting.

Item 16. The structure according to item 14, wherein the linear structure at least partially includes, in at least one part, a configuration in which the carbon nanotubes are bundled without twisting.

Item 17. A composite structure, wherein the structure according to any one of items 10 to 16 is compounded with any other material.

Item 18. The composite structure according to item 17, including a laminate configuration having, in at least one part, a structure layer constituted of the structure.

Item 19. The composite structure according to item 18, wherein the laminate configuration is a coaxial laminate configuration.

Item 20. The composite structure according to any one of items 17 to 19, including the structure as a skeleton configuration.

Item 21. A rope, including the structure according to any one of items 10 to 16, or the composite structure according to any one of items 17 to 20.

Item 22. An opening substrate, including the deposition base surface of the CNT forest according to any one of items 1 to 6.

Item 23. A device for producing a CNT forest, including the opening substrate according to item 22.

A method for producing the structure according to any one of items 10 to 16, including a spinning process of drawing the CNT from a spinnable portion of a CNT forest in a tubular opening substrate, and spinning the CNT.

Item 25. The method for producing the structure according to item 24, wherein the spinning process is provided for drawing the CNT in a direction of a central axis of a tubular opening substrate and spinning the CNT, and the method includes a twisting process of bundling the structure obtained in the spinning process by twisting.

Item 26. The method for producing the structure according to item 25, wherein the twisting process is performed in a position in which the CNT of the CNT forest is evenly consumed.

Item 27. A method for producing the composite structure according to item 17, including a spinning process of obtaining a web-like structure having an inside surface and an outside surface by drawing the CNT from a spinnable portion of a CNT forest in a tubular opening substrate, and spinning the CNT, and a compounding process of compounding the web-like structure obtained in the spinning process with any other material.

### Advantageous Effects of Invention

A CNT forest related to the invention can be applied as the CNT forest having excellent spinning properties by a construction having a spinnable portion at an end on a side of an open portion of the CNT forest formed on an inner surface of an opening substrate having an interior space.

Moreover, a CNT forest from which a structure spun by a closed spinning line can be obtained is provided by applying, as a spinnable portion, a whole of an end on a side of an open portion and spinning CNT from the spinnable portion. Such a CNT forest is expected to be excellent in spinning properties, and simultaneously is useful as a spinning source member of a structure that is easy to be stably compounded with any other material. Moreover, the invention provides a method for producing such a CNT forest. The invention also provides a spinning source member including the CNT forest, and a structure spun from the spinning source member.

### BRIEF DESCRIPTION OF DRAWINGS

FIG. 1 is a schematic diagram schematically showing a configuration of a cylindrical opening substrate on an inner surface of which a CNT forest related to one embodiment of the invention is formed, in which FIG. 1 (a) is a perspective view obtained by viewing the opening substrate from an obliquely lateral direction, FIG. 1 (b) is a front view viewed from a side of an open portion, and FIG. 1 (c) is a cross-sectional view in an A-A′ arrow direction, viewed from a side of a side surface of the opening substrate.

FIG. 2 is a photographic image showing one example of CNT constituting a CNT forest produced by a production method as related to one embodiment of the invention.

FIG. 3 is a graph showing one example of a distribution of an outer diameter of CNT constituting a CNT forest produced by a production method as related to one embodiment of the invention.

FIG. 4 is a schematic diagram schematically showing a configuration of an opening substrate different from the opening substrate in FIG. 1, in which FIG. 4(a) is a perspective view obtained by viewing a spindle hemispherical opening substrate from an obliquely lateral direction, FIG. 4(b) is a perspective view obtained by viewing a rectangular tubular opening substrate from an obliquely lateral direction, and FIG. 4 (c) is a perspective view obtained by viewing a cylindrical opening substrate different from the cylindrical opening substrate in FIG. 1 from an obliquely lateral direction.

FIG. 5 is a perspective view obtained by viewing, from an oblique upper direction, a state in which a splittable cylindrical opening substrate constituted by compounding two half-cylinders each having an identical shape related to one embodiment of the invention is disassembled.

FIG. 6 is a perspective view obtained by viewing, from an oblique upper direction, a state in which a splittable opening substrate according to another embodiment is disassembled.

FIG. 7 is a perspective view obtained by viewing, from an oblique upper direction, a state in which the state of the opening substrate being assembled in FIG. 5 is fixed by a fixing component.

FIG. 8 is a perspective view obtained by viewing, from an oblique upper direction, a state in which a splittable opening substrate according to another embodiment is disassembled.

FIG. 9 is a perspective view obtained by viewing, from an oblique upper direction, a state in which a splittable opening substrate according to another embodiment is disassembled.

FIG. 10 is a perspective view obtained by viewing, from an oblique upper direction, a state in which a splittable opening substrate according to another embodiment is disassembled.

FIG. 11 is a diagram schematically showing a construction of a production device used for producing a CNT forest related to one embodiment of the invention.

FIG. 12 is a flowchart showing a method for producing a CNT forest related to one embodiment of the invention.

FIG. 13 is a photographic image showing a state of producing a CNT entangled body by spinning a CNT forest produced by a production method as related to one embodiment of the invention.

FIG. 14 is a photographic image obtained by enlarging one part of a CNT entangled body obtained from a CNT forest produced by a production method as related to one embodiment of the invention.

FIG. 15 schematically shows an aspect in which CNT is spun from a CNT forest formed on the cylindrical opening substrate shown in FIG. 1 (c), in which FIG. 15 (a) is a cross-sectional view showing an initial stage, and FIG. 15 (b) is cross-sectional view showing a stage in which spinning has progressed.

FIG. 16 is a flowchart showing a method for producing a linear structure as related to one embodiment of the invention.

FIG. 17 schematically shows an aspect in which CNT spun from a CNT forest formed on the cylindrical opening substrate shown in FIG. 1(c) and bundled, in which FIG. 17(a) is a cross-sectional view showing an initial stage, and FIG. 17(b) is cross-sectional view showing a stage in which spinning has progressed.

FIG. 18 schematically shows an aspect in which CNT is spun from a CNT forest formed on the cylindrical opening substrate shown in FIGS. 1 (a) to 1 (c), in which FIG. 18 (a) is a perspective view, FIG. 18 (b) is a front view and FIG. 18 (c) is a cross-sectional view obtained by viewing a cross section in an A-A′ arrow direction in FIG. 18 (a) from a side of a side surface of the opening substrate.

FIG. 19 is a flowchart showing a method for producing a composite related to one embodiment of the invention.

FIG. 20 is a photograph substituted for drawing of a CNT forest produced by the production method according to Example 1 and a spun structure.

FIG. 21 is a schematic diagram schematically showing a conventional method in which CNT drawn from a planar substrate on which CNT is formed is bundled by twisting.

### DESCRIPTION OF EMBODIMENTS

Embodiments of the invention will be described below.

### 1. CNT Forest

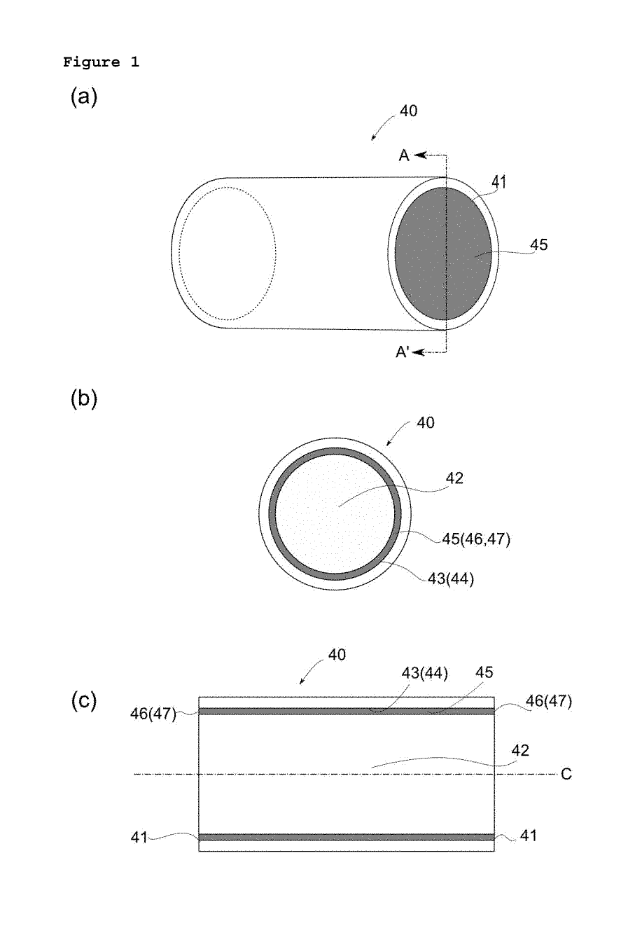

FIG. 1 is a schematic diagram schematically showing a configuration of a cylindrical opening substrate on an inner surface of which a CNT forest related to one embodiment of the invention is formed, in which FIG. 1 (a) is a perspective view obtained by viewing the opening substrate from an obliquely lateral direction, FIG. 1 (b) is a front view viewed from a side of an open portion, and FIG. 1 (c) is a cross-sectional view in an A-A′ arrow direction, viewed from a side of a side surface of the opening substrate.

One example of the CNT forest related to the present embodiment is, as shown in FIGS. 1 (a) to 1 (c), is CNT forest 45 formed by applying, as deposition base surface 44, inner surface 43 of opening substrate 40 having interior space 42 communicating with an outside through open portion 41, and has spinnable portion 47 at end 46 on a side of opening portion 41.

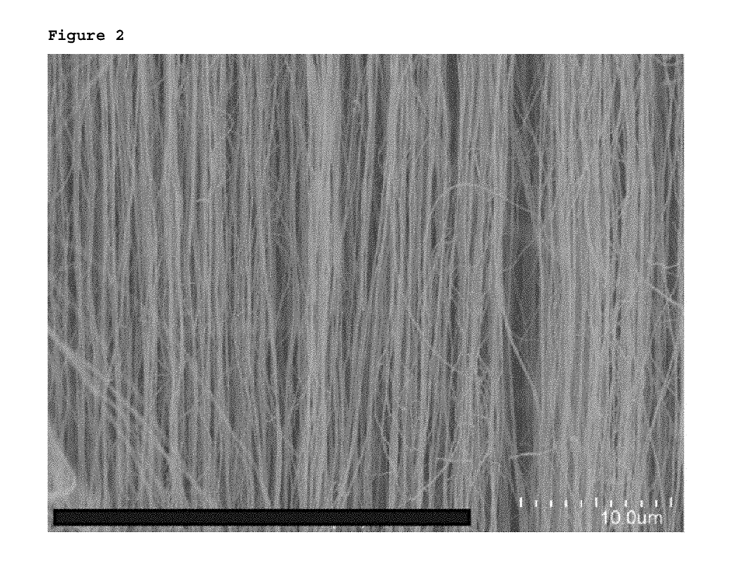

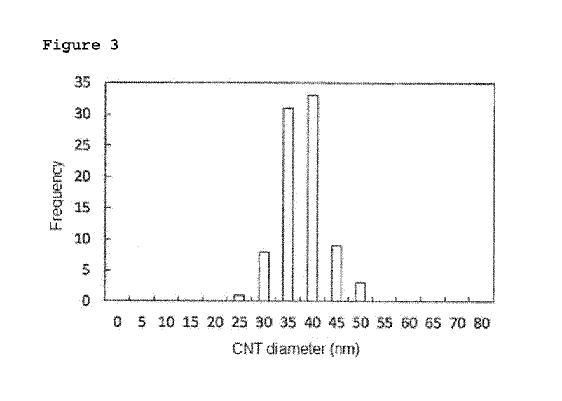

One example of the CNT forest related to the present embodiment includes, as shown in FIG. 2, a part having a configuration in such a manner that a plurality of CNT are aligned in a predetermined direction. When diameters of the plurality of CNT each in the part are measured and a distribution thereof is determined, a large number of the diameters of CNT fall within the range of 12 to 50 nanometers, as shown in FIG. 3.

“Spinnable portion” herein means a part having a construction capable of spinning the CNT from the CNT forest. The spinnable portion in which spinning of the CNT from the CNT forest can be performed from the part by processing the part into the CNT formed of depositing at density within the range of 10¹² pieces/m² to 10¹⁵ pieces/m² from a deposition base surface.

As shown in FIG. 1 (b), CNT forest 45 related to the present embodiment is formed in the construction in which CNT forest 45 is formed wholly at the end on the side of open portion 41. A whole of end 46 on the side of open portion 41 is formed into spinnable portion 47 in such a manner. Thus, a spinning line, being a virtual line formed of a CNT forest spinning position from which the CNT is spun, can be formed into a closed line. The spinning line is formed into the closed line. Thus, a tubular structure, a linear structure, a coaxial laminate structure, a rope or the like can be easily formed by a CNT entangled body.

CNT forest 45 of the present embodiment is formed by applying, as deposition base surface 44, inner surface 43 of opening substrate 40 having interior space 42. Therefore, the CNT forest can be formed in a wider area by effectively utilizing a space in comparison with a case where one plane is applied as the deposition base surface.

A method for producing the CNT forest is not limited, and the CNT forest may be produced by both a solid-phase catalyst process and a gas-phase catalyst process, but the gas-phase catalyst process is preferably applied thereto in order to effectively provide a catalyst onto inner surface 43 of opening substrate 40 having interior space 42.

### 2. Opening Substrate for Forming CNT Forest

The opening substrate for forming the CNT forest as related to one embodiment of the invention will be described with reference to drawings.

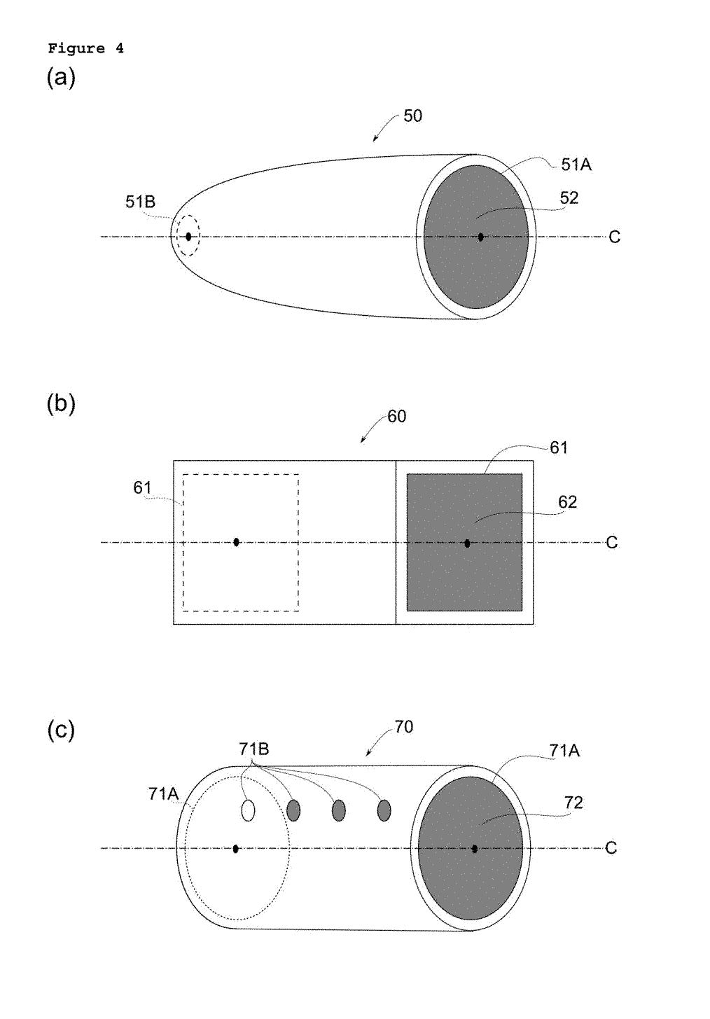

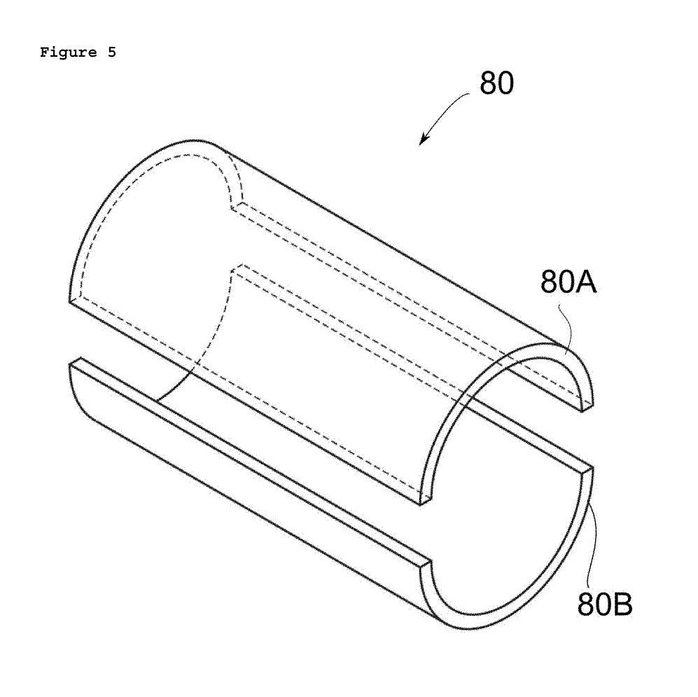

FIG. 4 is a schematic drawing schematically showing one example different from the cylindrical opening substrate shown in FIG. 1, in which FIG. 5 (a) is a perspective view of a spindle hemispherical opening substrate, FIG. 4 (b) is a perspective view of a rectangular tubular opening substrate, and FIG. 4(c) is a perspective view of a cylindrical opening substrate different from the substrate in FIG. 1.

The opening substrate for forming the CNT forest may be processed into the opening substrate in which, as in spindle hemispherical opening substrate 50 shown in FIG. 4 (a), an inner diameter of interior space 52 continuously changes, and sizes of open portions 51A and 51B at both ends are different. Moreover, as in quadrangular prism opening substrate 60 shown in FIG. 4 (b), the opening substrate for forming the CNT forest may be processed into the opening substrate in which interior space 62 is formed of a plurality of planes.

Specific examples of a material to form the opening substrate include silicon, quartz, glass and metal, but are not limited thereto. Moreover, the opening substrate can be formed by using an elastically deformable flexible sheet, a deformable sheet such as metal foil, or the like without limiting to a material having properties that are not easily deformed.

In opening substrates 40, 50 and 60 shown in FIG. 1 and FIGS. 4(a) and 4 (b), open portions 41, 51A, 51B and 61 are formed at both ends for each. However, as in opening substrate 70 shown in FIG. 4 (c), a construction may be applied, in which the substrate has not only open portions 71A at both ends of a tube but also open portions 71B on a side surface.

“Open portion” herein means a part in which a gas can be introduced into and/or discharged from the interior space of the opening substrate. The number of open portions of the opening substrate may be any of one or two or more. In the case of the open portion of the opening substrate having only one open portion, the gas is introduced into and discharged from a same open portion. On the other hand, if the opening substrate having two or more open portions is used, an open portion used for gas supply and an open portion used for gas discharge can be used in a different manner. Therefore, a smooth flow of the gas serving as a carbon source of the CNT forest can be formed. The smooth flow of the gas exerts a favorable influence on deposition of the CNT forest. Accordingly, the opening substrate having at least two open portions is preferably used.

The flow of the gas serving as the carbon source can be smoothened by forming a shape of the opening substrate having at least two open portions into a tubular shape. Deposition of the CNT forest on the deposition base surface on the inner surface can be uniformized by uniformizing the flow of the gas in a whole of the interior space of the opening substrate.

“Tubular” herein means an elongated and hollow substrate, and includes all of a substrate in which the inner diameter is changed as shown in FIG. 4 (a), a polygonal tubular substrate shown in FIG. 4 (b) and a substrate having open portions also on a side surface other than both ends as shown in FIG. 4 (c).

When the shape of the opening substrate is formed into a polygonal tubular shape, the rectangular tubular shape shown in FIG. 4(b) is preferred from a viewpoint of productivity. When the rectangular tubular shape is applied, the deposition base substrate on the inner surface thereof is formed of four planes, and an angle is formed by adjacent planes. The CNT forest formed in the part of the angle has a possibility of having properties different from the properties of the CNT forest formed on the plane. Therefore, upon spinning the CNT, the CNT may be individually spun for each plane forming the inner surface.

When the shape of the opening substrate is formed into a cylindrical shape, the CNT forest is formed by applying, as the deposition base surface, a smooth inner surface having no angle, which is different from the polygonal tubular shape. Therefore, uniformity of conditions when the CNT forest formed on the inner surface is deposited is improved by forming the opening substrate into the cylindrical shape. Accordingly, in order to enhance supply of the gas serving as the carbon source or uniformity of the shape of the deposition base surface on which the CNT forest is deposited, the shape is preferably formed into the cylindrical shape.

The opening substrate having two or more open portions is preferably formed into a bilateral opening substrate in which the open portions are formed at both ends, as in opening substrates 40, 50, 60 and 70 shown in FIG. 1 and FIGS. 4 (a) to 4 (c). The gas serving as the carbon source of CNT flows along the tube, and gas supply and discharge are further smoothed by forming the substrate into the bilateral opening substrate, and therefore the CNT forest is favorably deposited. In addition, “bilateral opening substrate” only needs be the substrate in which the open portions are formed at both ends of the tube, and includes the substrate in which the open portions are formed also on a side surface other than both ends, as in the opening substrate shown in FIG. 4 (c).

### 2-1. Splittable Opening Substrate

The opening substrate is a substrate on the inner surface of which the CNT forest is formed. Therefore, cleaning after spinning the CNT forest is facilitated by forming the substrate to be splittable. More specifically, at least one part of the inner surface of the opening substrate is exposed by splitting components of the opening substrate, and therefore the inner surface can be easily cleaned. An example of the opening substrate formed to be splittable is shown below.

FIG. 5 to FIG. 10 each are a perspective view obtained by viewing, from an oblique upper direction, a state in which a splittable opening substrate as related to an embodiment of the invention is disassembled. In the above Figures, an example in which the cylindrical opening substrates shown in FIGS. 1(a) to 1(c) each are formed into a splittable construction is described, but the opening substrates shown in FIGS. 4(a) to 4(c) can also be formed into the splittable construction in a similar manner.

FIG. 5 shows a splittable cylindrical opening substrate formed by combining two half-cylinders each having an identical shape. If a construction obtained by combining components 80A and 80B each having the identical shape is applied as in opening substrate 80 shown in the Figure, only components 80A and 80B each having a single shape can be produced as the components of the splittable opening substrate. Therefore, such an opening substrate can be produced at lower cost in comparison with the opening substrate prepared by combining different components.

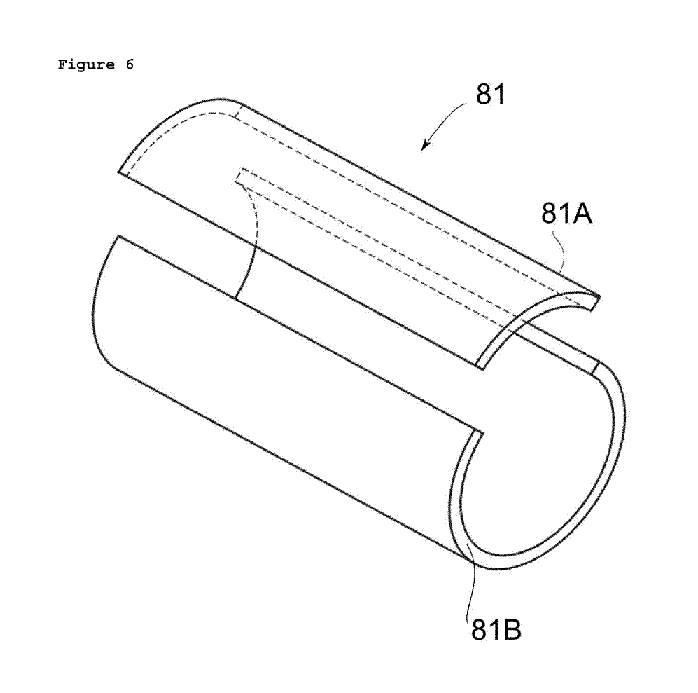

The splittable opening substrate can also be formed by combining two half-cylindrical components 81A and 81B each having a different shape, as in cylindrical opening substrate 81 shown in FIG. 6. In both opening substrates 80 and 81 shown in FIG. 5 and FIG. 6, the open portion is formed by assembling of two components.

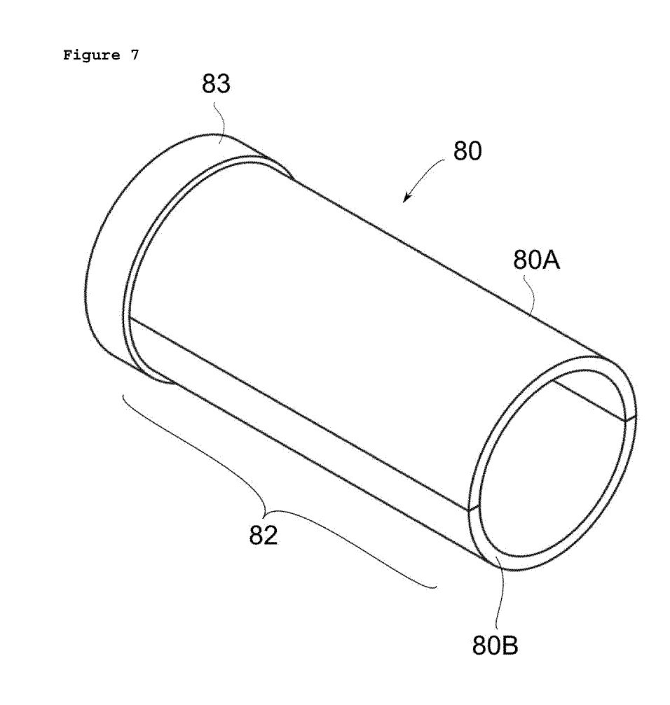

FIG. 7 is a perspective view obtained by viewing, from an oblique upper direction, a state in which the state of the opening substrate being assembled in FIG. 5 is fixed by a fixing component. In opening substrate 82 shown in the Figure, components 80A and 80B forming opening substrate 80 are fixed by using fixing component 83 that constrains components 80A and 80B from a side of an outer surface of opening substrate 80 into opening substrate 82 being assembly 82. According to the construction shown in FIG. 7, the state in which splittable opening substrate 82 is assembled, namely the assembly can be easily formed and retained.

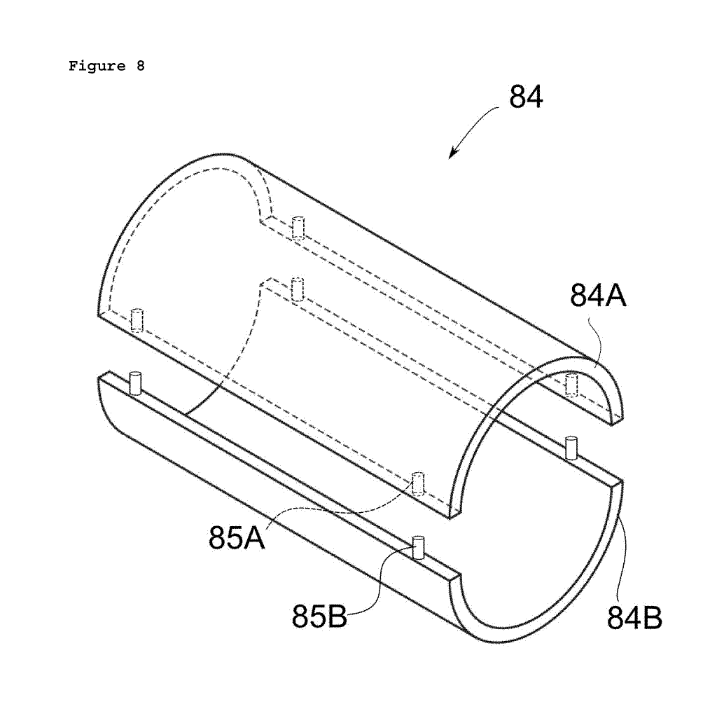

FIG. 8 to FIG. 10 each show one example of an embodiment in which positions of a plurality of components in an assembled state are determined by a fitting configuration of adjacent components. In the opening substrates shown in the Figures, two half-cylindrical components are combined into an assembly.

In opening substrate 84 shown in FIG. 8, recessed portion 85A and protruding portion 85B are formed on each interface of component 84A and component 84B. A relative positional relationship between component 84A and component 84B is fixed by fixing recessed portion 85A and protruding portion 85B into opening substrate 84 as the assembly. Thus, with regard to opening substrate 84, the relative positional relationship between component 84A and component 84B is fixed by a fixing configuration of recessed portion 85A of component 84A and protruding portion 85B of component 84B adjacent to component 84A into opening substrate 84 as the assembly.

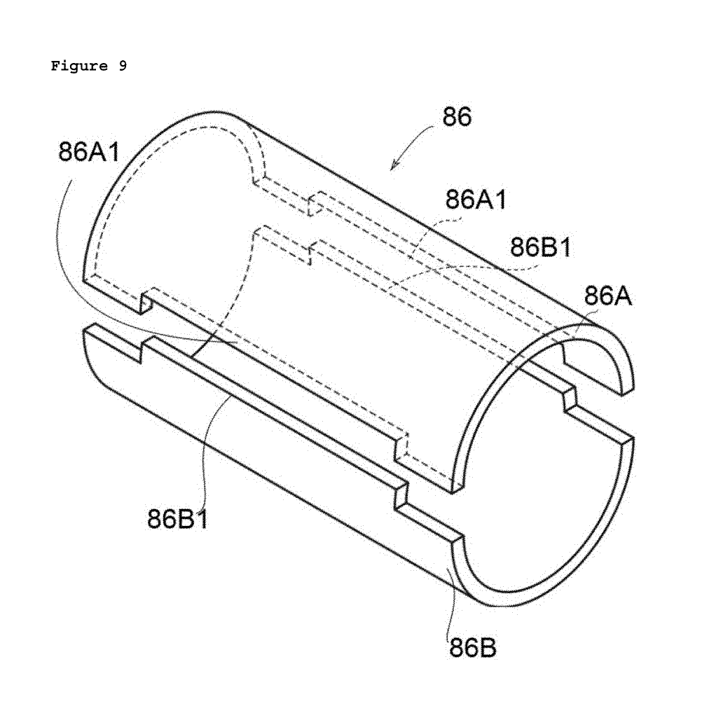

In opening substrate 86 shown in FIG. 9, each interface itself for component 86A and component 86B each is formed into recessed portion 86A1 and protruding portion 86B1. More specifically, one part of the inner surface of opening substrate 86 is formed by recessed portion 86A1 and protruding portion 86B1. Therefore, each interface itself for component 86A and component 86B each is fitted into opening substrate 86 as the assembly. As in opening substrate 86, the components can be positioned simply and with favorable precision by forming the configuration in which each interface itself is fitted.

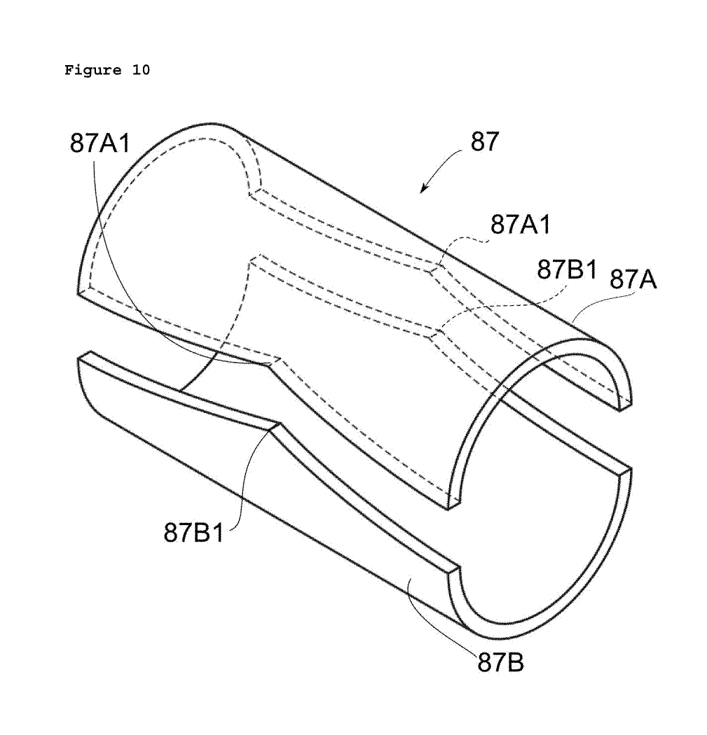

With regard to opening substrate 87 shown in FIG. 10, two half-cylindrical components 87A and 87B are combined into the assembly. Each interface itself for component 87A and component 87B each is formed as valley-shaped portion 87A1 in which a center is low, and a mountain-shaped portion 87B1 in which the center is high. If a fitting configuration of the valley shape and the mountain shape is thus applied, even if positions are somewhat shifted upon fitting the components, the components each can be easily and smoothly moved to a predetermined position, and therefore assembling is easy. In addition, FIG. 10 shows an example in which one valley-shaped portion or one mountain-shaped portion is provided on each interface, but a construction may be formed in which a plurality of the valley-shaped portions and the mountain-shaped portions are provided.

### 3. Device for Producing CNT Forest

A device for producing the CNT forest as related to one embodiment of the invention will be described with reference to drawings.

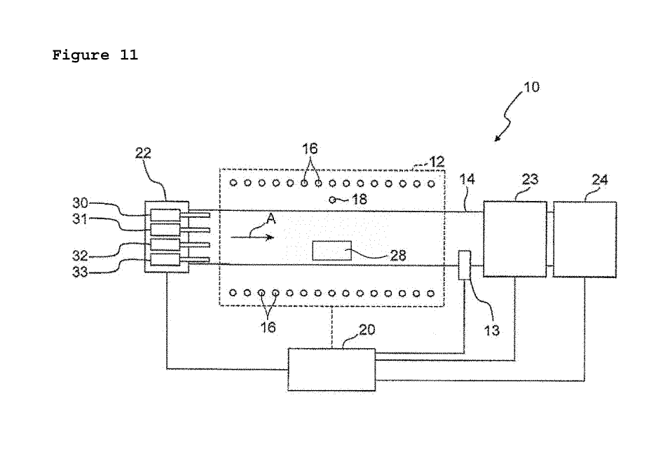

FIG. 11 is a diagram schematically showing a construction of a production device used for producing a CNT forest related to one embodiment of the invention.

As shown in FIG. 11, production device 10 has electric furnace 12. Electric furnace 12 has a substantially cylindrical shape extending along predetermined direction A (a direction in which a raw material gas flows). Reaction vessel pipe 14 as a carbon nanotube deposition chamber is passed through inside electric furnace 12. Reaction vessel pipe 14 is a substantially cylindrical member formed of a heat-resistant material such as quartz, has an outer diameter smaller than a diameter of electric furnace 12 and extends along predetermined direction A. In FIG. 11, opening substrate 28 is placed in reaction vessel pipe 14.

Electric furnace 12 has heater 16 and thermocouple 18. Heater 16 is arranged so as to surround a certain region of reaction vessel pipe 14 in direction A (in other words, a predetermined region of substantially cylindrical reaction vessel pipe 14 in an axial direction, and hereinafter, referred to as “heating region”) to generate heat for increasing temperature of an inter-tube atmosphere in the heating region of reaction vessel pipe 14. Thermocouple 18 is arranged in the vicinity of the heating region of reaction vessel pipe 14 inside electric furnace 12, and can output an electrical signal showing temperature in association with the temperature of the inter-tube atmosphere in the heating region of reaction vessel pipe 14. Heater 16 and thermocouple 18 are electrically connected to control device 20.

Gas supply device 22 is connected to one end of reaction vessel pipe 14 in predetermined direction A. Gas supply device 22 has raw material gas supply unit 30, gas-phase catalyst supply unit 31, gas-phase co-catalyst supply unit 32 and auxiliary gas supply unit 33. Gas supply device 22 is electrically connected to control device 20, and also electrically connected to each supply unit of gas supply device 22.

Raw material gas supply unit 30 is capable of supplying, into reaction vessel pipe 14, a raw material gas containing a carbon compound (for example, a hydrocarbon gas such as acetylene) serving as a raw material of the CNT constituting the CNT forest. A flow rate of supplying the raw material gas from raw material gas supply unit 30 can be regulated using a publicly known flow rate regulating instrument such as MASSFLOW.

Gas-phase catalyst supply unit 31 is capable of supplying a gas-phase catalyst into reaction vessel pipe 14. The gas-phase catalyst will be described later. A flow rate of supplying the gas-phase catalyst from gas-phase catalyst supply unit 31 can be regulated using the publicly known flow rate regulating instrument such as MASSFLOW.

Gas-phase co-catalyst supply unit 32 is capable of supplying a gas-phase co-catalyst into reaction vessel pipe 14. The gas-phase co-catalyst will be described later. A flow rate of supplying the gas-phase co-catalyst from gas-phase co-catalyst supply unit 32 can be regulated using the publicly known flow rate regulating instrument such as MASSFLOW.

Auxiliary gas supply unit 33 is capable of supplying gas other than the raw material gas, the gas-phase catalyst and the gas-phase co-catalyst, for example, an inert gas such as argon (such a gas is generically referred to as “auxiliary gas” herein) into reaction vessel pipe 14. A flow rate of supplying the auxiliary gas from gas-phase co-catalyst supply unit 32 can be regulated by using the publicly known flow rate regulating instrument such as MASSFLOW.

To the other end of reaction vessel pipe 14 in predetermined direction A, pressure regulating valve 23 and exhaust device 24 are connected. Pressure regulating valve 23 is capable of regulating pressure within reaction vessel pipe 14 by varying a degree of opening and closing of the valve. Exhaust device 24 performs vacuum exhaust of the inside of reaction vessel pipe 14. Specific types of exhaust device 24 are not particularly limited, and a rotary pump, an oil diffusion pump, a mechanical booster, a turbomolecular pump, a cryopump or the like can be used alone or in combination therewith. Pressure regulating valve 23 and exhaust device 24 are electrically connected to control device 20. Moreover, pressure gauge 13 for measuring internal pressure thereof is provided within reaction vessel pipe 14. Pressure gauge 13 is electrically connected to control device 20 and is capable of outputting an electrical signal showing the pressure within reaction vessel pipe 14 to control device 20.

As described above, control device 20 is electrically connected to heater 16, thermocouple 18, gas supply device 22, pressure gauge 13, pressure regulating valve 23 and exhaust device 24 to input the electrical signal output from the devices or the like, and based on the input electrical signal, to control operation of the devices or the like. Examples of specific operation of control device 20 will be described below.

Control device 20 is capable of inputting the electrical signal output from thermocouple 18 and related to internal temperature within reaction vessel pipe 14, and is capable of outputting, to heater 16, a control signal related to operation of heater 16 as determined based on the electrical signal. Heater 16 to which the control signal from the control device is input performs, based on the control signal, operation of increasing or decreasing an amount of generated heat to change internal temperature in the heating region of reaction vessel pipe 14.

Control device 20 is capable of inputting the electrical signal output from pressure gauge 13 and related to internal pressure within the heating region of reaction vessel pipe 14, and is capable of outputting, to pressure regulating valve 23 and exhaust device 24, a control signal related to operation of pressure regulating valve 23 and exhaust device 24 as determined based on the electrical signal. Pressure regulating valve 23 and exhaust device 24 to which the control signal from control device 20 is input perform, based on the control signal, operation of varying a degree of opening of pressure regulating valve 23, or varying exhausting capability of exhaust device 24, or the like.

Control device 20 is capable of outputting, to each device, the control signal for controlling the operation of each device or the like according to a preset timetable. For example, control device 20 is capable of outputting, to supply device 22, the control signal for determining start and stop of supplying gas from each of raw material gas supply device 30, gas-phase catalyst supply device 31, gas-phase co-catalyst supply device 32 and auxiliary gas supply device 33 of gas supply device 22. Supply device 22 to which the control signal is input operates each supply device according to the control signal to start or stop supply of each gas such as the raw material gas into reaction vessel pipe 14.

### 4. Method for Producing CNT Forest

A method for producing the CNT forest as related to one embodiment of the invention will be described with reference to drawings.

The method for producing the CNT forest of the invention includes a depositing process of forming the CNT forest on the deposition base surface of the opening substrate. Specific examples include, as one embodiment, a method in which a depositing process includes two steps of a first step and a second step.

### (1) First Step

A first step is a step of allowing the opening substrate to exist in the atmosphere containing the gas-phase catalyst. Specific one embodiment thereof includes a process of allowing an opening substrate including a deposition base surface being a surface formed of a material containing silicon oxide as at least one part of the surface thereof to exist in the atmosphere containing the gas-phase catalyst.

A specific construction of the opening substrate is not particularly limited. A shape only needs have an interior space communicating with an outside through an open portion, and the shape may be a simple shape such as a spherical shape, an elliptic spherical shape, a rectangular tube and a cylinder, or a three-dimensional shape provided with complicated recesses and protrusions. Moreover, a whole surface of the opening substrate may be the deposition base surface, or may be in a so-called patterned state in which only one part of the surface of the opening substrate is the deposition base surface and other parts are not the deposition base surface.

The deposition base surface is a surface formed of a material containing silicon oxide, for example, and in the second step, the CNT forest is formed on the deposition base surface. A detail of the material forming the deposition base surface is not limited, as long as the material contains silicon oxide. Specific one example of the material forming the deposition base surface includes quartz (SiO₂). Specific another example of the material forming the deposition base surface includes SiOₓ (x≦2), which can be obtained by sputtering silicon thereon in the atmosphere containing oxygen. Specific another example includes composite oxide containing silicon. Specific elements composing the composite oxide, other than silicon and oxygen, include Fe, Ni and Al. Specific another example includes a compound in which a non-metal element such as nitrogen and boron is added to silicon oxide.

The material forming the deposition base surface may be identical with or different from the material forming the opening substrate. Specific examples include a case where a material forming an opening substrate is quartz and a material forming a deposition base surface is also quartz, and a case where a material forming an opening substrate is a silicon substrate containing, as a main component, silicon, and a material forming a deposition base surface is an oxide film thereof.

In the first step, the opening substrate having the deposition base surface is allowed to exist in the atmosphere containing the gas-phase catalyst. Specific examples of the gas-phase catalyst related to the present embodiment include halide of iron family element (namely, at least one kind of iron, cobalt and nickel) (also referred to as “iron family element halide” herein). Specific examples of the iron family element halide further include iron fluoride, cobalt fluoride, nickel fluoride, iron chloride, cobalt chloride, nickel chloride, iron bromide, cobalt bromide, nickel bromide, iron iodide, cobalt iodide and nickel iodide. In the iron family element halide, different compounds exist according to valence of iron family element ion, such as iron(II) chloride and iron (III) chloride in several cases. The gas-phase catalyst may be composed of one kind of substance or a plurality of kinds of substances.

A method for supplying the gas-phase catalyst into the reaction vessel pipe is not limited. As in production device 10 described above, the gas-phase catalyst may be supplied from gas-phase catalyst supply unit 31, or the gas-phase catalyst may be allowed to exist inside the heating region of reaction vessel pipe 14 by placing a material (also referred to as “catalyst source” herein) in a physical state other than a gas phase (typically a solid-phase state) in which the gas-phase catalyst is given inside the heating region of reaction vessel pipe 14 and producing the gas-phase catalyst from the catalyst source by heating the inside of the heating region of reaction vessel pipe 14 and/or negatively pressurizing the inside. To show a specific example of a case where the gas-phase catalyst is produced by using the catalyst source, if anhydrous iron(II) chloride is arranged, as the catalyst source, inside the heating region of reaction vessel pipe 14, and the inside of the heating region of reaction vessel pipe 14 is heated and simultaneously negatively pressurized to sublimate anhydrous ion (II) chloride, the gas-phase catalyst composed of iron(II) chloride vapor can be allowed to exist in reaction vessel pipe 14.

Pressure of the atmosphere in reaction vessel pipe 14, specifically in a part in which the opening substrate is placed in the first step is not particularly limited. The pressure may be atmospheric pressure (about 1.0×10⁵ Pa), negative pressure or positive pressure. When the pressure in reaction vessel pipe 14 is adjusted to the negative pressure in the second step, the atmosphere is preferably adjusted to the negative pressure also in the first step to shorten transition time between the steps. When the inside of reaction vessel pipe 14 is adjusted to a negative pressure atmosphere in the first step, specific total pressure of the atmosphere is not particularly limited. Specific one example includes adjustment to 10⁻² Pa or more and 10⁴ Pa or less.

Temperature of the atmosphere in reaction vessel pipe 14 in the first step is not particularly limited. The atmosphere may be at normal temperature (about 25° C.), heated or cooled. The atmosphere inside the heating region of reaction vessel pipe 14 is preferably heated in the second step as described below. Thus, the atmosphere in the region is preferably heated also in the first step to shorten the transition time between the steps. When the atmosphere inside the heating region of reaction vessel pipe 14 is heated in the first step, the temperature of the heating region is not particularly limited. Specific one example includes adjustment to 8×10² K or higher and 1.3×10³ K or lower, and preferably 9×10² K or higher and 1.2×10³ K or lower.

When anhydrous iron(II) chloride is used as the catalyst source, the atmosphere inside the heating region of reaction vessel pipe 14 is preferably heated also in the first step, as described above, to meet conditions in which the catalyst source is sublimated. In addition, sublimation temperature of iron(II) chloride is 950 K at atmospheric pressure (about 1.0×10⁵ Pa), but the sublimation temperature can be decreased by adjusting the atmosphere inside the heating region of reaction vessel pipe 14 to the negative pressure.

Anhydrous iron(II) chloride may be used as the catalyst source, and vapor of iron(II) chloride may be supplied from gas-phase catalyst supply unit 31 as one part of the gas-phase catalyst. In the above case, the first step can be completed by heating and subliming anhydrous iron(II) chloride arranged in gas-phase catalyst supply unit 31 and introducing the produced vapor of iron(II) chloride into reaction vessel pipe 14 in which opening substrate 28 is placed.

### (Second Step)

The second step is a step in which a plurality of carbon nanotubes are deposited on the deposition base surface of the opening substrate by allowing the raw material gas and the gas-phase co-catalyst to exist in the atmosphere containing the gas-phase catalyst realized in the first step to obtain the CNT forest constituted of the plurality of carbon nanotubes.

A kind of the raw material gas is not particularly limited, but ordinarily a hydrocarbon-based material is used, and specific examples include acetylene. A method for allowing the raw material gas to exist in the atmosphere in reaction vessel pipe 14 is not particularly limited. As in producing device 10 described above, the second step may be started by allowing the raw material gas to exist therein by supplying the raw material gas from raw material gas supply unit 30, or by arranging in advance a material that is capable of producing the raw material gas in reaction vessel pipe 14, producing the raw material gas from the material to diffuse the produced raw material gas into reaction vessel pipe 14. When the raw material gas is supplied from raw material gas supply unit 30, a flow rate of supplying the raw material gas into reaction vessel pipe 14 is preferably controlled using the flow rate regulating instrument. The flow rate of supply is ordinarily expressed in terms of a unit of sccm, and 1 sccm means a flow rate of 1 mL per minute for gas converted under an environment of 273 K and 1.01×10⁵ Pa. In the case of production device having the configuration as shown in FIGS. 11, the flow rate of the gas to be supplied into reaction vessel pipe 14 is set up based on an inner diameter of reaction vessel pipe 14, pressure measured in pressure gauge 13, or the like. Specific examples of a preferred flow rate of supplying an acetylene-containing raw material gas in the case where the pressure in pressure gauge 13 is 1×10² Pa or more and within 1×10³ Pa include 10 sccm or more and 1,000 sccm or less, and in the above case, the flow rate is further preferably adjusted to 20 sccm or more and 500 sccm or less, and particularly preferably, to 50 sccm or more and 300 sccm or less.

“Gas-phase co-catalyst” herein means a component having a function (hereinafter, also referred to as “deposition promotion function”) for enhancing a deposition rate of the CNT forest to be produced by the gas-phase catalyst process described above, and in preferred one aspect, the component having a function for further improving the spinning properties of the CNT forest produced (hereinafter, also referred to as “function for improving spinning properties”). A detail of the deposition promotion function is not particularly limited. Specific one example includes reduction of activation energy as related to deposition of the CNT forest. Moreover, a detail of the function for improving spinning properties is not particularly limited, either. Specific one example includes an increase in a spinning length of the CNT entangled body obtained.

Specific components of the gas-phase co-catalyst are not particularly limited as long as the components fulfill the deposition promotion function described above, and preferably, also the function for improving the spinning properties, and specific one example includes acetone. Acetone as the gas-phase co-catalyst is capable of reducing activation energy of a reaction upon deposition of the CNT forest by the gas-phase catalyst process, and simultaneously is capable of exerting a favorable influence on the spinning length upon spinning among characteristics related to the spinning properties of the CNT forest obtained. Details of the functions will be described in Examples.

A method of allowing the gas-phase co-catalyst to exist in the atmosphere in reaction vessel pipe 14 in the second step is not particularly limited. As in producing device 10 described above, the gas-phase co-catalyst may be allowed to exist therein by supplying the gas-phase co-catalyst from gas-phase co-catalyst supply unit 32, or by allowing a material capable of producing the gas-phase co-catalyst to exist in reaction vessel pipe 14 in advance, and producing the gas-phase co-catalyst from the material by a means of heating, pressure reduction or the like to diffuse the gas-phase co-catalyst obtained into reaction vessel pipe 14.

When the gas-phase co-catalyst is supplied from gas-phase co-catalyst supply unit 32, the flow rate of supplying the gas-phase co-catalyst into reaction vessel pipe 14 is preferably controlled using the flow rate regulating instrument. Specific examples of the flow rate of supplying acetone being one example of the gas-phase co-catalyst when the pressure in the pressure gauge 13 is 1×10² Pa or more and within 1×10³ Pa include preferably 10 sccm or more and 1,000 sccm or less, and in the above case, further preferably adjusted to 20 sccm or more and 500 sccm or less, and particularly preferably adjusted to 50 sccm or more and 300 sccm or less. When the raw material gas (specifically, acetylene) and the gas-phase co-catalyst (specifically, acetone) are supplied from the raw material gas supply unit 30 and gas-phase co-catalyst supply unit 32, respectively, a ratio of the flow rate (unit: sccm) of supplying the gas-phase co-catalyst to the flow rate of supplying the raw material gas (gas-phase co-catalyst/raw material gas) is adjusted preferably to 150% or less, further preferably to 5% or more and 120% or less, and particularly preferably to 10% or more and 100% or less. The deposition rate of the CNT forest can be further stably improved by adjusting the ratio to such a level.

As described above, a degree of the deposition promotion function of acetone as the gas-phase co-catalyst varies depending on a quantitative relationship with the raw material gas, and an effect of incorporating acetone as the gas-phase co-catalyst thereinto is relatively further significantly confirmed in an initial stage of the reaction, and therefore acetone as the gas-phase co-catalyst has a possibility of further strongly involving in a relatively initial stage in the process of depositing the CNT forest by an interaction of the raw material gas with the catalyst.

In the second step, timing of allowing the raw material gas to exist in the atmosphere in reaction vessel pipe 14 and timing of allowing the gas-phase co-catalyst to exist therein are not particularly limited. Either the raw material gas or the gas-phase co-catalyst may be prior to the other, or both are simultaneous. However, when the gas-phase co-catalyst is allowed to exist prior to the other or simultaneously, deposition of the CNT forest based on the interaction of the raw material gas with the gas-phase catalyst is prevented from starting before introduction of the gas-phase co-catalyst, which is different from the method for producing the CNT forest by the conventional gas-phase catalyst process. Therefore, an advantage of incorporating the gas-phase co-catalyst thereinto can be sufficiently obtained. Therefore, the gas-phase co-catalyst is preferably set to exist in the atmosphere in reaction vessel pipe 14 prior to or simultaneously with the raw material gas.

The auxiliary gas may be allowed to exist in the atmosphere in reaction vessel pipe 14 in the second step for the purpose of regulating a total pressure to a predetermined range, for example. Specific examples of the auxiliary gas include a gas having a relatively small influence on formation of the CNT forest, more specifically an inert gas such as argon and nitrogen. A method of allowing the auxiliary gas to exist in the atmosphere in reaction vessel pipe 14 is not particularly limited. As in production device 10 described above, a case where the supply device has auxiliary gas supply unit 33 to supply the auxiliary gas from auxiliary gas supply unit 33 into the atmosphere in reaction vessel pipe 14 is simple and has excellent controllability, and such a case is preferred.

The total pressure in the atmosphere in reaction vessel pipe 14 is not particularly limited, and may be atmospheric pressure (about 1.0×10⁵ Pa), negative pressure or positive pressure. The total pressure should be appropriately set up in consideration of a composition (partial pressure ratio) of substances existing in the atmosphere in reaction vessel pipe 14, or the like. To show a specific example of the pressure range when the atmosphere inside the heating region of reaction vessel pipe 14 is adjusted to the negative pressure, the pressure is 1×10¹ Pa or more and 1×10⁴ Pa or less, preferably 2×10¹ Pa or more and 7×10³ Pa or less, further preferably 5×10¹ Pa or more and 5×10³ Pa or less, and particularly preferably 1×10² Pa or more and 2×10³ or less.

Temperature of the atmosphere inside the heating region of reaction vessel pipe 14 in the second step is not particularly limited as long as the CNT forest can be formed using the raw material gas in the atmosphere in which the gas-phase catalyst and the gas-phase co-catalyst exist. When the gas-phase catalyst is obtained by heating the catalyst source such as iron(II) chloride described above, the temperature of the atmosphere inside the heating region of reaction vessel pipe 14 is set at a level equal to or higher than temperature at which the gas-phase catalyst is formed.

Temperature of the deposition base surface in the second step is preferably heated at 8×10² K or higher. When the temperature of the deposition base surface is 8×10² K or higher, an interaction of the gas-phase catalyst and the gas-phase co-catalyst with the raw material gas is easily caused on the deposition base surface, and the CNT forest is easily deposited on the deposition base surface. From a viewpoint of further easily causing the interaction, as the temperature of the deposition base surface in the second step, the surface is preferably heated to 9×10² K or higher. An upper limit of the temperature of the deposition base surface in the second step is not particularly limited. However, when the temperature is excessively high, the material forming the deposition base surface and the material forming the opening substrate (the materials are identical in several cases) lack in stability as a solid in several cases. Therefore, the upper limit is preferably set in consideration of a melting point or sublimation temperature of the materials. If a load of the reaction vessel pipe is taken into consideration, the upper limit of the temperature is preferably set at a level up to about 1.8×10³ K.

### 5. Spinning Source Member

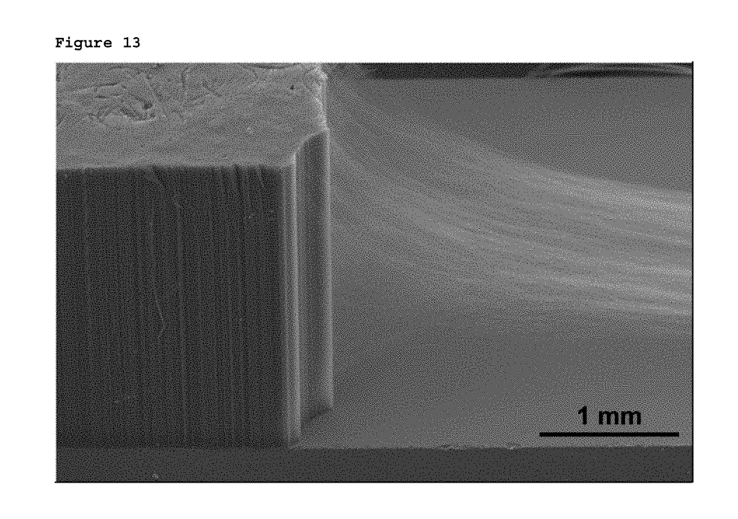

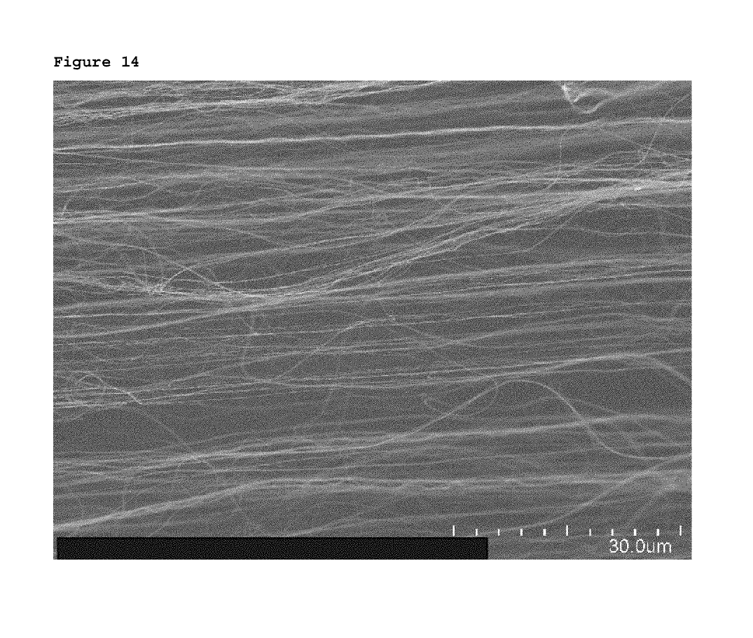

Such a CNT forest produced by the production method as related to the present embodiment has excellent spinning properties. Specifically, a structure (CNT entangled body) having a plurality of CNT entangled to each other can be obtained by drawing (spinning), in a direction separating from the CNT forest, the CNT from the spinnable portion of an end portion of the CNT forest. FIG. 13 is a photographic image showing a state in which a CNT entangled body is formed from a CNT forest, and FIG. 14 is a photographic image obtained by enlarging one part of a CNT entangled body. As shown in FIG. 13, the CNT entangled body is formed by continuously drawing the CNT constituting the CNT forest. Moreover, as shown in FIG. 14, the CNT constituting the CNT entangled body is entangled to each other while aligning in a direction (spinning direction) in which the CNT is drawn from the CNT forest to form a connected body. A member including the CNT forest, and the member capable of forming the CNT entangled body herein is also referred to as “spinning source member.”

The CNT forest that may be the spinning source member only needs be the CNT forest capable of forming the CNT entangled body, but specific preferred aspect in term of a shape includes a CNT forest having a high level in a CNT forest deposition height (height in a state in which the CNT forest is formed). More specifically, when the CNT forest deposition height is sufficiently high, a degree of CNT entanglement is increased, and the CNT is easily continuously spun. Ease of forming the CNT entangled body from the CNT forest (spinning properties) can be evaluated by a length of the CNT entangled body formed from the CNT forest in the spinning direction (length in a direction of drawing the CNT from the CNT forest). The CNT forest that is long in the spinning direction and is capable of forming the CNT entangled body without discontinuation is preferred (a case where the CNT forest is wholly spun without discontinuation and consumed is most preferred).

The CNT forest produced by the production method using the gas-phase co-catalyst as related to the present embodiment has a wider range of the CNT forest deposition height in which the spinning properties are favorable, in comparison with the CNT forest produced by a production method according to the conventional technology, namely the gas-phase catalyst process in which no gas-phase co-catalyst is used. More specifically, according to the production method using the gas-phase co-catalyst, the spinning properties of the CNT forest constituted of long CNT or the CNT forest constituted of short CNT become favorable. In other words, the CNT entangled body constituted of CNT having a length that has been unable to be produced when the CNT forest according to the conventional process is used can be further stably produced by applying, as the spinning source member, the CNT forest produced by the production method as related to the present embodiment.

Excellence in the spinning properties of the CNT forest produced by the production method as related to the present embodiment will be specifically described below. When the CNT entangled body is formed using the CNT forest to be produced by the gas-phase catalyst process using acetone as the raw material gas and anhydrous iron(II) chloride as the catalyst source, the CNT forest deposition height namely, a CNT length range in which favorable spinning properties (specific examples include a length of 1 centimeter or more) are obtained is limited to a predetermined range. An upper limit thereof and a lower limit thereof are generally about 0.5 millimeters in terms of a height range (upper limit height—lower limit height), although a level varies depending on production conditions. In contrast, in the case of the CNT forest produced by the method in which acetone is used as the gas-phase co-catalyst in the gas-phase catalyst process, the CNT forest deposition height range in which the spinning properties become favorable can be extended in both the upper limit and the lower limit to be twice or more, in other words, 1 millimeter or more, and in a preferred one aspect, to reach three times or more, in other words, 1.5 millimeters or more, in comparison with the case in which no gas-phase co-catalyst is used.

To describe the excellence in the spinning properties of the CNT forest produced by the production method as related to the present embodiment from another view point, with regard to the CNT forest produced by the production method as related to the present embodiment, the CNT can be stably spun to be 1 centimeter or more in the spinning length in one preferred aspect, even when the CNT forest deposition height is 2 millimeters or more.

Such a CNT forest having excellence in the spinning properties can be further easily produced by using the gas-phase co-catalyst in the gas-phase catalyst process. In the case of the solid-phase catalyst process, a process of producing the CNT forest is different from the process of the gas-phase catalyst process, and therefore a basic configuration of the CNT forest obtained is also possibly different from the basic configuration in the case of the gas-phase catalyst process, but circumstances in which application of the production method of the invention thereto is precluded are not found.

An increase in the upper limit of the CNT forest deposition height range in which the spinning properties becomes favorable is preferred from a viewpoint of improving characteristics of the CNT entangled body obtained from the CNT forest. More specifically, the CNT entangled body obtained from the CNT forest having a large deposition height value is relatively large in a value of a length of the CNT constituting the CNT entangled body in a major axis direction, and therefore a degree of an inter-CNT interaction is easily increased. Therefore, mechanical characteristics (for example, tensile strength), electrical characteristics (for example, volume conductivity), thermal characteristics (for example, heat conductivity) and so forth when the CNT entangled body has a thread-like shape, a web-like shape are easily improved.

A reason why the spinning source member including the CNT forest produced by the production method as related to the present embodiment are excellent in the spinning properties as described above is not known for certain. When drawing (spinning) of the CNT from the CNT forest continuously progresses, the CNT drawn are properly entangled to each other, and simultaneously properly interact also with the CNT existing in a nearest position (herein after, also referred to as proximate CNT) on a side opposite to a direction in which the CNT is drawn in a drawing direction thereof. Thus, the proximate CNT is drawn. Accordingly, in order to increase the spinning length in the CNT entangled body spun from the CNT forest, a balance is required to be proper regarding an interaction of the CNT to be drawn with the CNT already drawn, and an interaction of the CNT to be drawn with the proximate CNT. A spinning co-catalyst is possibly involved in forming the CNT forest in which the balance between the interactions described above becomes proper.

### 6. Structure

The CNT entangled body obtained from the spinning source member can have various shapes. Specific one example includes a linear shape, and specific another example includes a web-like shape. The linear CNT entangled body can be handled in a manner equivalent to fibers, and can also be used as electrical wiring. Moreover, the web-like CNT entangled body can be directly handled in a manner similar to a non-woven fabric.

The length of the CNT entangled body in the spinning direction is not particularly limited, and should be appropriately set up according to an intended use. In general, if the spinning length is 2 millimeters or more, the CNT entangled body can be applied to a component level such as a contact unit and an electrode. Moreover, with regard to the web-like CNT entangled body, a degree of alignment of the CNT constituting the web-like CNT entangled body can be arbitrarily controlled by varying a spinning method from the spinning source member. Accordingly, the CNT entangled body in which the mechanical characteristics or the electrical characteristics are different can be produced by varying the spinning method from the spinning source member.

With regard to the CNT entangled body, if a degree of entanglement thereof is minimized, the CNT entangled body becomes fine in the case of the linear shape, and thin in the case of the web-like shape. If the degree progresses, the CNT entangled body becomes difficult to be visually confirmed, and the CNT entangled body on the above occasion may be used as transparent fibers, transparent wiring or a transparent web (transparent sheet-form member).

The spinning source member of the present embodiment has favorable spinning properties, and therefore a web-like structure can be obtained. “Web-like” herein means a cobweb-like, woven-cloth-like or non-woven cloth-like structure formed by entanglement of the fibers in a complicated manner.

For example, if a tubular member is used as opening substrate 28, a tubular structure having an inside surface and an outside surface is obtained as the web-like structure. If the tubular web-like structure is cut open, a sheet-like structure is obtained.

Moreover, if the CNT bundled by twisting, a twisted thread as the linear structure is obtained, and if the CNT bundled without twisting, an untwisted thread as the linear structure is obtained. Moreover, a rope can be prepared using, as one part thereof, the twisted thread or the untwisted thread. When the CNT bundled by twisting, a side of the opening substrate may be rotated, or a side of threads obtained by bundling the linear structures may be rotated.

### 7. Method for Producing Structure

A method for producing a structure as related to one embodiment of the invention will be described.

A method for producing a web-like structure having an inside surface and an outside surface and the linear structure among the structures will be described below.

### 7-1. Method for Producing Web-Like Structure

The web-like structure having the inside surface and the outside surface as related to the present embodiment can be produced by spinning CNT from the spinnable portion formed wholly at the end on the side of the open portion of the CNT forest formed on the inner surface of the tubular opening substrate.

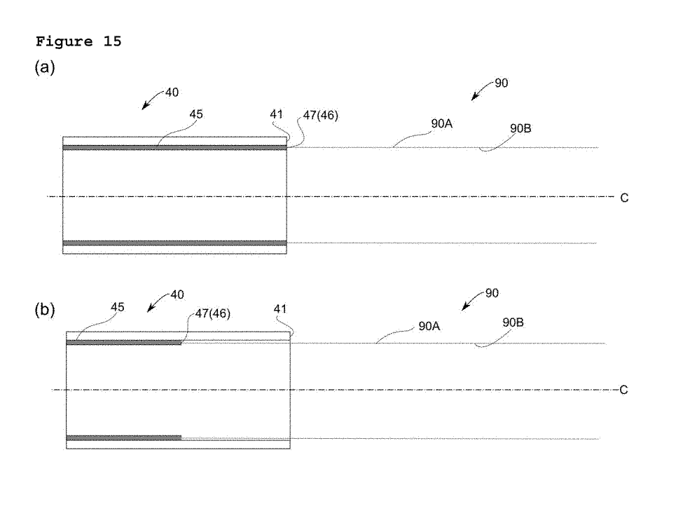

FIG. 15 schematically shows an aspect in which CNT spun from a CNT forest formed on the cylindrical opening substrate shown in FIG. 1(c) and bundled, in which FIG. 15(a) is a cross-sectional view showing an initial stage, and FIG. 15(b) is cross-sectional view showing a stage in which spinning has progressed.

As shown in FIG. 15 (a), web-like structure 90 having inside surface 90A and outside surface 90B is obtained by drawing CNT from spinnable portion 47 wholly at end 46 of CNT forest 45. The cylindrical structure having inside surface 90A and outside surface 90B can be easily obtained by a process of drawing the CNT from spinnable portion 47 in a direction in parallel to central axis C of cylindrical opening substrate 40.

As shown in FIG. 15 (b), CNT forest 45 is consumed in association with progress of spinning, and end 46 moves from open portion 41 of opening substrate 40 to an inside. Therefore, when spinning is suspended and then resumed, end 46 is positioned inside opening substrate 40.

### 7-2 Method for Producing Linear Structure

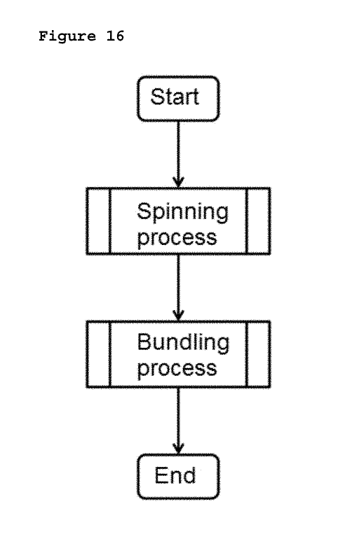

The method for producing the linear structure as related to the present embodiment includes a spinning process and a bundling process as shown in FIG. 16.

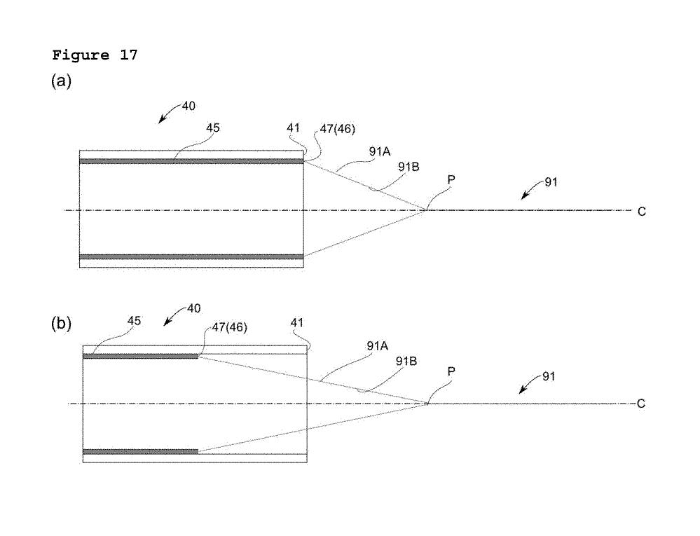

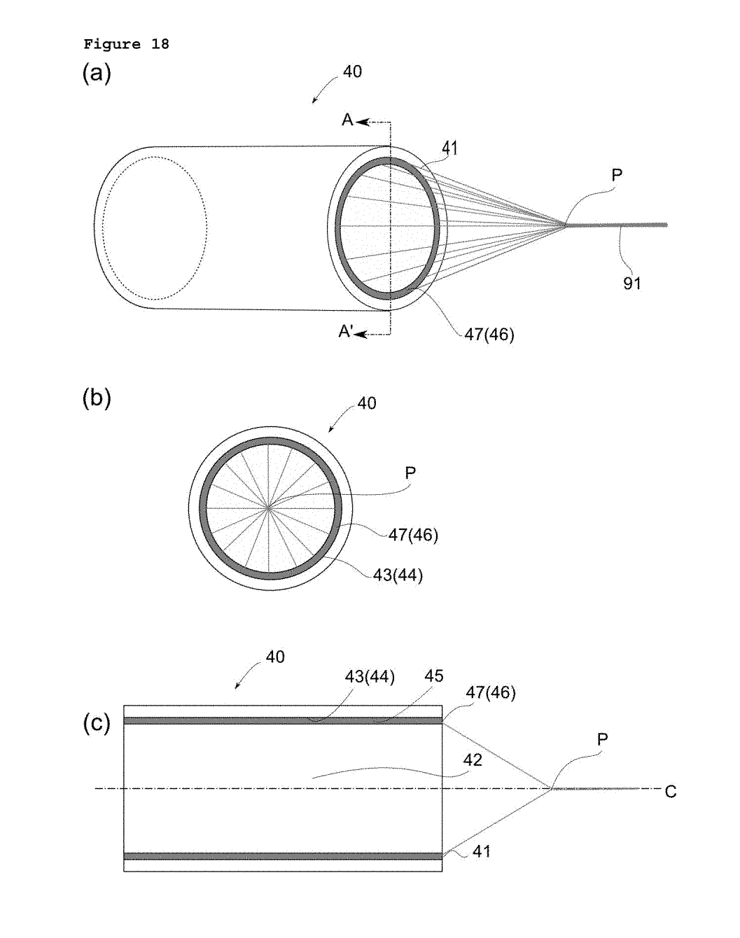

FIGS. 17(a) to 17 (b) and FIGS. 18 (a) to 18 (c) each is a diagram showing an aspect in which CNT is spun from the CNT forest formed on the cylindrical opening substrate shown in FIGS. 1(a) to 1 (c).

FIG. 17(a) is a cross-sectional view showing an initial stage, and FIG. 17(b) is a cross-sectional view showing a stage in which spinning has progressed. FIGS. 18(a) to 18(c) each schematically show an aspect in which the CNT is spun from the CNT forest formed on the cylindrical opening substrate, in which FIG. 18(a) is a perspective view, FIG. 18(b) is a front view and FIG. 18(c) is a cross-sectional view. In FIGS. 18(a) to 18(c), the CNT entangled body spun from spinnable portion 47 at end 46 in CNT forest 45 is schematically shown using a plurality of lines for convenience, but the CNT entangled body is spun from a whole of end 46 as a tubular body. Moreover, FIG. 18(a) shows only spinnable portion 47 at end 46 in CNT forest 45 formed on inner surface 43 of opening substrate 40.

### (Spinning Process)

In the method for producing the linear structure, the CNT entangled body spun from spinnable portion 47 of CNT forest 45 is drawn in a direction of central axis C of opening substrate 40 in FIG. 18(a) and bundled at bundling point P into the linear structure. When a highly symmetrical opening substrate such as opening substrate 40 is used, the CNT can be spun from spinnable portion 47 in any part of end 46 of CNT forest 45 under even conditions, and therefore the opening substrate becomes excellent in the spinning properties. An amount of consumption of the CNT forest can be evaluated using a length of consumption of CNT forest 45, for example. In the case of the cylindrical opening substrate such as opening substrate 40, if bundling point P is applied on central axis C, the CNT can be spun under the even conditions. The spinning process can be performed under “even conditions” in which an amount of consumption in a part in which CNT forest 45 is least consumed is in the range of 80 to 100% of an amount of consumption in a part in which CNT forest 45 is most consumed by applying bundling point P on central axis C of opening substrate 40. However, bundling point P is not necessarily applied on central axis C in order to spin the CNT under the even conditions. Moreover, the linear structure may be produced by applying bundling point P on an arbitrary place and without evening the conditions upon spinning. A favorable linear structure can be obtained by pulling the CNT in such a manner that the structure has a spindle shape.

### (Bundling Process and Twisting Process)

The bundling process is a process in which the CNT spun in the spinning process is bundled into the linear structure. Upon forming the linear structure in the bundling process, the twisted thread is obtained if the CNT is twisted, and an untwisted thread is obtained if the CNT is not twisted.

In the following, a case where the bundling process is a twisting process in which the CNT is twisted into the twisted thread.

FIG. 21 is a schematic diagram schematically showing a conventional method in which CNT drawn from a planar substrate on which CNT is formed is bundled by twisting. As shown in the Figure, if the CNT drawn from places on the planar substrate on which CNT forest 15 is formed is bundled by twisting, the CNT on both sides of CNT forest 105 are consumed faster than the CNT in a center. The reason is that, if twisted thread 110 being the linear structure is twisted at bundling point P, twisted thread 110 is formed into a configuration in which external threads 107A and 107C (each shown by a dotted line) spun from the vicinity of both sides 106A and 106C of end 106 surround middle thread 107B (shown by a solid line) spun from the vicinity of center 106B, and therefore are consumed in a larger amount than an amount of middle thread 107B. More specifically, with regard to a length used per a unit length of twisted thread 110, external threads 107A and 107C surrounding the middle thread become longer than linear middle thread 107B, and therefore as shown in FIG. 21, the CNT preferentially consumed from both sides of CNT forest 105, and the CNT forest in the vicinity of the center remains on the substrate.

In contrast, the method for producing the structure of the present embodiment is an art in which the CNT spun from the CNT forest formed on the inner surface of cylindrical opening substrate 40 is twisted in the twisting process. Therefore, the structure drawn from a specific region on the substrate is prevented from being formed into the middle thread or the external thread by regulating a direction of drawing the CNT to evenly consume the CNT forest.

For example, if bundling point P at which the twisting process is performed is applied on or in the vicinity of central axis C of opening substrate 40, a relative positional relationship between a position in which the CNT is twisted and a position from which the CNT is spun can be equalized. Accordingly, the CNT entangled body drawn from the specific region on the opening substrate is prevented from being exclusively formed into the middle thread or the external thread, and the CNT forest can be evenly consumed. “Position in which the CNT forest is evenly consumed” herein means that a position in which an amount of consumption in a part in which the CNT forest is least consumed is in the range of 80 to 100% of an amount of consumption in a part in which the CNT forest is most consumed.

### 8. Composite Structure

The CNT entangled body may consist essentially of CNT or may be a composite structure with any other material. As described above, the CNT entangled body has the configuration formed of entanglement of the plurality of CNT to each other, and therefore voids exist among the plurality of entangled CNT in a manner similar to a plurality of the fibers constituting the non-woven fabric. The composite structure can be easily formed by introducing powder (specific examples include metal fine particles, inorganic particles such as silica and organic particles such as particles of an ethylene-based polymer) into a void portion thereof or impregnating a liquid thereinto.

Moreover, a surface of CNT constituting the CNT entangled body may be modified. An outside surface of CNT is formed of graphene, and therefore the CNT entangled body is hydrophobic as is, but the CNT entangled body can be hydrophilized by applying hydrophilic treatment to the surface of CNT constituting the CNT entangled body. Specific one example of such a hydrophilization means includes plating treatment. In the above case, the CNT entangled body obtained is formed into the composite structure between CNT and a plated metal.

The composite structure can be formed into a laminate configuration including, in at least one part, a structure layer formed of the structure. For example, if a linear member serving as a core is arranged on an inside surface of a cylindrical structure to bundle the CNT, a composite structure having a coaxial laminate configuration can be obtained. Moreover, if a rope having, in one part thereof, the composite structure is formed, the rope can be provided with properties of the composite.

The composite structure may include the structure having the CNT entangled body as a skeleton configuration. “Having the structure as a skeleton configuration” herein means a configuration including the structure as a center for forming the composite structure composed by compounding a plurality of materials. For example, among the plurality of materials forming the composite structure, a material in which the structure occupies a maximum volume or maximum mass corresponds to “having the structure as a skeleton configuration.”

### 9. Method for Producing Composite Structure

A method for producing the composite structure as related to one embodiment of the invention will be described.

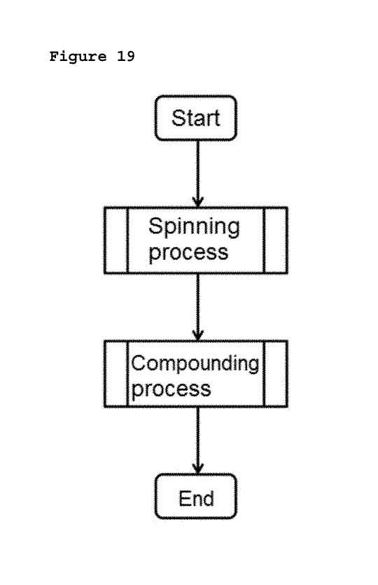

The method for producing the composite structure as related to the present embodiment includes a spinning process and a compounding process, as shown in FIG. 19.

### (Spinning Process)

The spinning process is similar to the spinning process in the method for producing the structure as described above. When the cylindrical structure is formed, the CNT is drawn in a direction in parallel to central axis C of the opening substrate and spun as shown in FIG. 15, and when the linear structure is formed, the CNT is drawn in a direction of central axis C of the opening substrate and spun as shown in FIG. 17 to FIG. 18.

### (Compounding Process)

The compounding process is a process in which the web-like structure obtained in the spinning process is compounded with any other material. The web-like structure obtained in the spinning process has the inside surface and the outside surface. The composite structure can be easily formed by introducing powder (for example, metal fine particles, inorganic particles such as silica, and organic particles such as particles of an ethylene-based polymer) into the inside surface of the web-like structure, or by impregnating the liquid thereinto. A larger amount of composite material can be compounded than ever before by adding the composite material to the inside surface. Moreover, a stable composite structure is formed by surrounding the added composite material with the web-like structure.

### EXAMPLES

The invention will be further specifically described by way of Examples or the like, but the scope of the invention is not limited to the Examples or the like.

### Example 1

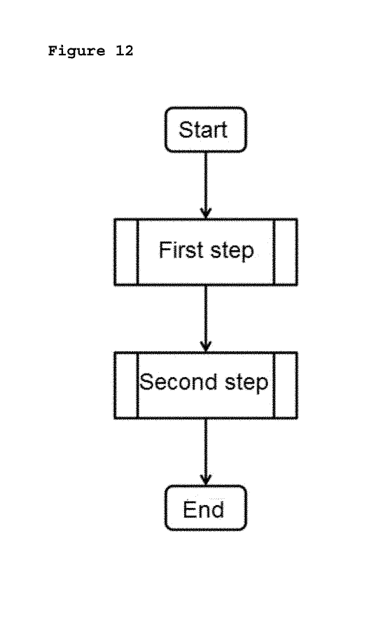

A CNT forest was produced using a production device having a configuration shown in FIG. 11, and by a production method shown in FIG. 12.

Specifically, first, a first step was executed as described below.

In a reaction vessel pipe of the production device having the configuration shown in FIG. 11, cylindrical quartz (outer diameter: 18 mm, inner diameter: 15 mm, length: 20 mm) was placed on a boat formed of quartz. Accordingly, in the present Example, a material forming a deposition base surface and a material forming an opening substrate both were quartz. Moreover, 130 mg of anhydrous iron (II) chloride as a catalyst source was placed on a part other than the boat in the reaction vessel pipe.

An inside of the reaction vessel pipe was exhausted to 1×10⁻¹ Pa or less using an exhaust device, and then the inside of the reaction vessel pipe (including the opening substrate) was heated to 1.1×10³ K. As a result, anhydrous iron(II) chloride in the reaction vessel pipe was sublimated, and an inside of a heating region of the reaction vessel pipe was converted into an atmosphere containing the gas-phase catalyst formed of anhydrous iron(II) chloride as a catalyst source.

The first step was executed as described above, and then a second step was executed by supplying, at 200 (sccm), acetylene as a raw material gas from a raw material gas supply part and supplying, at 10 (sccm), acetone as a gas-phase co-catalyst from a gas-phase co-catalyst supply unit into the reaction vessel pipe, respectively, while maintaining atmosphere pressure at 4.5×10² Pa using a pressure regulating valve and simultaneously maintaining temperature in the reaction vessel pipe (including the opening substrate) at 1.1×10³ K using a heater.

A CNT forest was deposited on the deposition base surface by starting the second step, namely, starting supply of acetylene and acetone. The CNT forest was obtained by depositing the CNT forest for 7 minutes from starting the second step.

Heating by the heater was ended and the temperature in the reaction vessel pipe was confirmed to be room temperature, and then exhaust in the reaction vessel pipe by the exhaust device was ended, and atmospheric air was introduced into the reaction vessel pipe into atmospheric pressure (1×10⁵ Pa) in the atmosphere pressure. Then, the reaction vessel pipe was opened and the CNT forest was removed with the opening substrate.

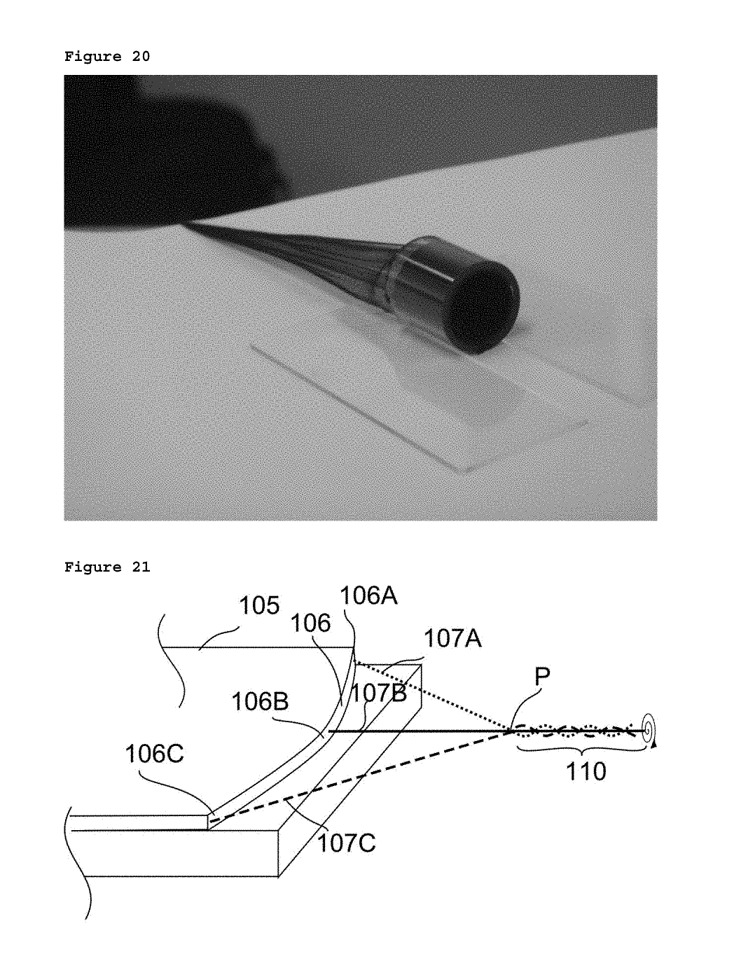

One part of the CNT including the CNT positioned on a side surface of an end of the CNT forest was taken, and the taken CNT was pulled so as to be separated from the CNT forest. As a result, a web-like structure having an inside surface and an outside surface and having a plurality of carbon nanotubes entangled to each other as shown in FIG. 20 was obtained.

A tubular structure in which the side surface was continuous was obtained by using the CNT forest obtained as described above and taking one of the CNT including the CNT positioned on the side surface of the end of the CNT forest and pulling the taken CNT so as to be separated from the CNT forest. A reason why the CNT forest having such favorable spinning properties was obtained is considered such that spinning properties were improved by using acetone being a gas-phase co-catalyst in addition to a raw material gas.

The CNT forest formed by applying, as the depositing base surface, the inner surface in the opening substrate having an interior space and the CNT forest formed on a planar substrate are different in physical conditions (environment) upon production, and therefore factors influencing properties as the spinning properties are possibly different. For example, an air flow or a temperature distribution in the reaction vessel pipe is well known to be influenced by a shape of an object placed in the reaction vessel pipe. Accordingly, how the CNT forest is influenced by change of a substrate placed in the reaction vessel pipe from the planar substrate to a further three-dimensional opening substrate is not clear.

In the case of a gas-phase catalyst process, in particular, a shape of the substrate has a large influence on a state of a sublimed catalyst in the reaction vessel pipe. Therefore, conditions for obtaining the CNT forest having favorable spinning properties are significantly influenced by the shape of the substrate used. Accordingly, conditions contributed to improvement of the spinning properties when the planar substrate is used are far from effective also to the CNT forest formed on the inner surface of the further three-dimensional opening substrate.

### INDUSTRIAL APPLICABILITY

A CNT entangled body obtained from a CNT forest produced by a method for producing the CNT forest as related to the invention is preferably used as electrical wiring, a heater, a stretchable sheet-form strain sensor or a transparent electrode sheet, for example.

### REFERENCE SIGNS LIST

10: Production device
12: Electric furnace
13: Pressure gauge
14: Reaction vessel pipe
16: Heater
18: Thermocouple
20: Control device
22: Gas supply device
23: Pressure regulating valve
24: Exhaust device
28: Opening substrate
30: Material gas supply unit
31: Gas-phase catalyst supply unit
32: Gas-phase co-catalyst supply unit
33: Auxiliary gas supply unit
40, 50, 60, 70: Opening substrate
41, 51A, 51B, 61, 71A, 71B: Open portion
42, 52, 62, 72: Interior space
43: Inner surface
44: Deposition base surface
45: CNT forest
46: End
47: Spinnable portion
80, 81, 82, 84, 86, 87: Opening substrate
80A, 80B, 81A, 81B, 84A, 84B, 86A, 86B, 87A, 87B: Component
83: Fixing component
85A: Recessed portion
85B: Protruding portion
86A1: Recessed portion
86B1: Protruding portion
87A1: Valley-shaped portion
87B1: Mountain-shaped portion
90, 91: Structure
90A: Inside surface
90B: Outside surface

What is claimed is:

1. A CNT forest that is formed by applying, as a deposition base surface, at least one part of an inner surface in an opening substrate having an interior space communicating with an outside through an open portion, wherein the CNT forest has a spinnable portion at an end of the open portion.

2. The CNT forest according to claim 1, wherein the spinnable portion is formed wholly at the end of the open portion

3. The CNT forest according to claim 1, wherein the opening substrate has at least two of the open portions.

4. The CNT forest according to claim 3, wherein the opening substrate is tubular.

5. The CNT forest according to claim 4, wherein the opening substrate is a bilateral opening substrate in which the open portions are formed on both ends of the opening substrate being tubular.

6. The CNT forest according to claim 5, wherein the opening substrate is cylindrical.

7. A method for producing a CNT forest, comprising a deposition process of forming the CNT forest on the deposition base surface of the opening substrate according to claim 1.

8. The method for producing the CNT forest according to claim 7, wherein the deposition process comprises a first step of allowing the opening substrate to exist in an atmosphere containing a gas-phase catalyst, and a second step of depositing a plurality of carbon nanotubes on the deposition base surface of the opening substrate by allowing a raw material gas and a gas-phase co-catalyst to exist in the atmosphere containing the gas-phase catalyst to obtain the CNT forest constituted of the plurality of carbon nanotubes on the deposition base surface.

9. A spinning source member, comprising the CNT forest according to claim 1.

10. A structure spun from the spinning source member according to claim 9, wherein the structure comprises a plurality of carbon nanotubes entangled to each other.

11. The structure according to claim 10, wherein a length of the structure in a spinning direction is 10 millimeters or more.

12. The structure according to claim 10 or 11, wherein the structure is a web-like structure.

13. The structure according to claim 12, wherein the web-like structure has an inside surface and an outside surface.

14. The structure according to claim 10, wherein the structure is a linear structure.

15. The structure according to claim 14, wherein the linear structure comprises, in at least one part, a configuration in which the carbon nanotubes are bundled by twisting.

16. The structure according to claim 14, wherein the linear structure comprises, in at least one part, a configuration in which the carbon nanotubes are bundled without twisting.

17. A composite structure, wherein the structure according to claim 10 is compounded with any other material.

18. The composite structure according to claim 17, comprising a laminate configuration having, in at least one part, a structure layer constituted of the structure.

19. The composite structure according to claim 18, wherein the laminate configuration is a coaxial laminate configuration.

20. The composite structure according to claim 17, comprising the structure as a skeleton configuration.

21. A rope, comprising the structure according to claim 10, or a composite structure according to in which the structure according to claim 10 is compounded with another material.

22. An opening substrate, comprising the deposition base surface of the CNT forest according to claim 1.

23. A device for producing a CNT forest, comprising the opening substrate according to claim 22.

24. A method for producing the structure according to claim 10, comprising a spinning process of drawing the CNT from a spinnable portion of a CNT forest in a tubular opening substrate, and spinning the CNT.

25. The method for producing the structure according to claim 24, wherein the spinning process is provided for drawing the CNT in a direction of a central axis of a tubular opening substrate and spinning the CNT, and the method for producing the structure comprises a twisting process of bundling the structure obtained in the spinning process by twisting.

26. The method for producing the structure according to claim 25, wherein the twisting process is performed in a position in which the CNT of the CNT forest is evenly consumed.

27. A method for producing the composite structure according to claim 17, comprising:
a spinning process of obtaining a web-like structure having an inside surface and an outside surface by drawing the CNT from a spinnable portion of a CNT forest in a tubular opening substrate, and spinning the CNT; and
a compounding process of compounding the web-like structure obtained in the spinning process with any other material.
